(19) United States
(12) Patent Application Publication
(10) Pub. No.: US 2011/0024359 A1
(43) Pub. Date: Feb. 3, 2011

(54) METHOD FOR REMOVING CHLORIDE FROM AQUEOUS SOLUTION

(75) Inventors: Jiyang Xia, Shanghai (CN); Wenqing Peng, Shanghai (CN); Rihua Xiong, Shanghai (CN); Wei Cai, Shanghai (CN); Chang Wei, Niskayuna, NY (US); Yujiang Zhong, Shanghai (CN)

Correspondence Address: GENERAL ELECTRIC COMPANY;GLOBAL RESEARCH, ONE RESEARCH CIRCLE, BLDG. K1-3A59, NISKAYUNA, NY, 12309, US

(73) Assignee: GENERAL ELECTRIC COMPANY, Schenectady, NY (US)

(21) Appl. No.: 12/511,157

(22) Filed: Jul. 29, 2009

(51) Int. Cl. C02F 1/52

(52) U.S. Cl. 210/723; 210/738

(57) ABSTRACT

A method for removing chloride from an aqueous solution having an initial chloride ion (Cl⁻) weight concentration, comprising: adding a magnesium compound to the aqueous solution, magnesium ion weight concentration being less than about 20% of the initial chloride ion weight concentration; adding at least two compounds comprising calcium ions (Ca²⁺), hydroxide ions (OH⁻) and aluminate ions (AlO₂⁻), wherein pH of the aqueous solution is greater than about 10 after addition of the at least two compounds; and stirring for precipitation.

### BACKGROUND

Chloride is a deleterious ionic species in aqueous solutions, e.g., cooling water systems, because it promotes corrosion.

Thermal zero liquid discharge (ZLD) is desired in some applications where low/no liquid is intended to discharge as waste. However, the presence of high chloride concentration in water solutions or even slurries requires high grade but expensive titanium material in thermal zero liquid discharge (ZLD) unit to accommodate the high chloride concentration water solutions or slurries because of its resistance to chloride corrosion, which results in high cost of thermal ZLD.

Currently, one way to reduce chloride in aqueous solutions is to precipitate it as calcium chloroaluminate using the ultra-high lime with aluminum process (UHLA). However, UHLA is not efficient enough. It would be desirable to have a method for removing chloride from aqueous system that has a high efficiency and thus reduces cost for the system.

### BRIEF DESCRIPTION

In accordance with embodiments described herein, a method is provided for removing chloride from an aqueous solution having an initial chloride ion (Cl⁻) weight concentration, comprising: adding a magnesium compound to the aqueous solution, magnesium ion weight concentration being less than about 20% of the initial chloride ion weight concentration; adding at least two compounds comprising calcium ions (Ca²⁺), hydroxide ions (OH⁻) and aluminate ions (AlO₂⁻), wherein pH of the aqueous solution is greater than about 10 after addition of the at least two compounds; and stirring for precipitation.

### DETAILED DESCRIPTION

Although embodiments of chloride removal methods described herein may be utilized for any application in which chlorides are to be removed from a liquid, for exemplary purposes only the chloride removal method will be described in terms of a wastewater treatment method, for example, a desalination method used in, such as, thermal zero liquid discharge (ZLD) system.

Approximating language, as used herein throughout the specification and claims, may be applied to modify any quantitative representation that could permissibly vary without resulting in a change in the basic function to which it is related. Accordingly, a value modified by a term or terms, such as “about” or “substantially”, is not to be limited to the precise value specified. In some instances, the approximating language may correspond to the precision of an instrument for measuring the value.

In accordance with embodiments described herein, a method is provided for removing chloride from an aqueous solution having an initial chloride ion (Cl⁻) weight concentration, comprising: adding a magnesium compound to the aqueous solution, magnesium ion weight concentration being less than about 20% of the initial chloride ion weight concentration; adding at least two compounds comprising calcium ions (Ca²⁺), hydroxide ions (OH⁻) and aluminate ions (AlO₂⁻), wherein pH of the aqueous solution is greater than about 10 after addition of the at least two compounds; and stirring for precipitation.

Concentrations of calcium ions, aluminate ions and magnesium ions in the aqueous solution affect the performance of chloride removal. In some embodiments, calcium ions (Ca²⁺) weight concentration in the aqueous solution is from about 5 times to about 10 times of the initial chloride ion (Cl⁻) weight concentration. Aluminate ions (AlO₂⁻) weight concentration in the aqueous solution is from about 1 time to about 3 times of the initial chlorine ion (Cl⁻) weight concentration. Magnesium ion weight concentration in the aqueous solution is from about 2% to about 15% of the initial chloride ion (Cl⁻) weight concentration.

Stirring strength affects the performance of chloride removal too. In some embodiments, a power consumption of the stirring is in a range of from about 10 W/m³ to about 55 W/m³. In some specific embodiments, a power consumption of the stirring is about 28 W/m³, magnesium ion (Mg²⁺) weight concentration is about 6% to about 15% of the initial chloride ion (Cl⁻) weight concentration in the aqueous solution.

In some embodiments, the method is operated at a temperature of 20° C.˜25° C. In some embodiments, the at least two compounds comprise calcium hydroxide and sodium aluminate. In some embodiments, the at least two compounds comprise calcium oxide and sodium aluminate, or additionally comprise sodium hydroxide. In some embodiments, the at least two compounds comprise calcium aluminate and sodium hydroxide, or additionally comprise calcium hydroxide or calcium nitrate. In some embodiments, the at least two compounds comprise calcium aluminate and calcium hydroxide. In some embodiment, pH of the aqueous solution is greater than about 12 after addition of the at least two compounds. In some embodiment, the magnesium compound comprises magnesium chloride or magnesium nitrate.

The following examples are included to provide additional guidance to those of ordinary skill in the art in practicing the claimed invention. Accordingly, these examples do not limit the invention as defined in the appended claims.

In the following experiments, the chemicals used were: calcium hydroxide (1305-62-0, Sinopharm Chemical Reagent Co. Ltd, Shanghai, China), sodium aluminate (11138-49-1, Sinopharm Chemical Reagent Co. Ltd, Shanghai, China), sodium chloride (7647-14-5, Sinopharm Chemical Reagent Co. Ltd, Shanghai, China), and magnesium chloride hexahydrate (7791-18-6, Sinopharm Chemical Reagent Co. Ltd, Shanghai, China).

IC (Ion Chromatography) used in the experiments is the process of separating ions (positively or negatively charged atoms or molecules) from a solution using a stationary phase that contains oppositely charged ions. There are two types of ion chromatography: anion exchange chromatography and cation exchange chromatography, which are used to measure negatively and positively changed ions respectively. The IC device used in the examples is Dionex ICS 2500.

### EXAMPLES

Several sets of equilibrium experiments were conducted at room temperature (20° C.˜25° C.), in which magnesium ion concentrations and stirring strengths varied. The initial total chloride concentrations in each of test samples were fixed at 1065 ppm, which is an average concentration found in recycled wastewater systems. The amount of calcium hydoxide in each of the samples were 0.74 g (14800 ppm) and the amount of sodium aluminate in each of the samples was 0.123 g (2460 ppm). All solutions were prepared with deionized water (DI water).

The stirring was done by a shaker (INFORS HT Minitron) at three different rotation speeds (150 rpm (11.7 W/m³), 200 rpm (27.7 W/m³), and 250 rpm (54.1 W/m³)), respectively. Weight concentrations of magnesium ions in the samples are respectively set as 0, 24.3 ppm, 48.6 ppm, 72.9 ppm, 97.2 ppm, 121.5 ppm, 145.8 ppm, 170.1 ppm, and 194.4 ppm and each concentration has a duplicate sample, named as sample A and sample B.

The experiments were performed as follows. Added suitable amount of magnesium chloride to a sodium chloride solution in a reactor to get a 50 ml of solution in which the total chloride concentration was 1065 ppm. Added dry calcium hydroxide (0.74 g, 14800 ppm) and dry sodium aluminate (0.123 g, 2460 ppm) to the reactor. PH of the solution right after addition of the calcium hydroide and soldium aluminate was about 12.7. Placed the reactors in the shaker to mix for one hour. Released the reactors from the shaker and centrifugally separated mixtures in the reactors. Detected the concentration of chloride ions in the supernates from the centrifugal separation using IC. Tables 1 and 2 below show the resulted chloride concentrations and chloride removal percentages, respectively, in which the chloride removal percentage means the percentage of removed chloride concentration (initial concentration minus resulted concentration) versus the initial chloride concentration.

TABLE 1

| magnesium | | | | | | | |
|---|---|---|---|---|---|---|---|
| concentration | | chloride concentration in different shaker rotation speeds | | | | | |
| | Mg/ | (ppm) | | | | | |
| Mg | Cl | 150 rpm | | 200 rpm | | 250 rpm | |
| (ppm) | (%) | A | B | A | B | A | B |
| 0 | 0 | 715.74 | 716.12 | 737.40 | 734.80 | 722.41 | 723.02 |
| 24.3 | 2.28 | 702.45 | 703.67 | | | 716.90 | 716.21 |
| 48.6 | 4.56 | 706.56 | 707.10 | 740.70 | 741.80 | 700.07 | 699.39 |
| 72.9 | 6.85 | 702.06 | 703.73 | | | 710.22 | 710.17 |
| 97.2 | 9.13 | 709.45 | 711.11 | 696.20 | 695.70 | 730.05 | 727.13 |
| 121.5 | 11.41 | 714.30 | 711.52 | | | 729.24 | 732.06 |
| 145.8 | 13.69 | 713.41 | 713.51 | 723.50 | 732.00 | 724.29 | 723.90 |
| 170.1 | 15.97 | 705.50 | 704.95 | | | 739.87 | 741.21 |
| 194.4 | 18.25 | 707.83 | 707.63 | 749.50 | 755.50 | 730.42 | 730.81 |

TABLE 2

| | | chloride removal | | | | | |
|---|---|---|---|---|---|---|---|
| magnesium | | percentage in different rotation speeds (%) | | | | | |
| concentration | | 150 rpm | | 200 rpm | | 250 rpm | |
| Mg (ppm) | Mg/Cl (%) | A | B | A | B | A | B |
| 0 | 0 | 32.79 | 32.76 | 30.76 | 31.00 | 32.17 | 32.11 |
| 24.3 | 2.28 | 34.04 | 33.93 | | | 32.69 | 32.75 |
| 48.6 | 4.56 | 33.66 | 33.61 | 30.45 | 30.35 | 34.27 | 34.33 |
| 72.9 | 6.85 | 34.08 | 33.92 | | | 33.31 | 33.32 |
| 97.2 | 9.13 | 33.38 | 33.23 | 34.63 | 34.68 | 31.45 | 31.72 |
| 121.5 | 11.41 | 32.93 | 33.19 | | | 31.53 | 31.26 |
| 145.8 | 13.69 | 33.01 | 33.00 | 32.07 | 31.27 | 31.99 | 32.03 |
| 170.1 | 15.97 | 33.76 | 33.81 | | | 30.53 | 30.40 |
| 194.4 | 18.25 | 33.54 | 33.56 | 29.62 | 29.06 | 31.42 | 31.38 |

As can be seen from Tables 1 and 2, when the rotation speed of the shaker was 150 rpm, addition of magnesium in the whole experimented concentration range increases chloride removal percentages compared with when no magnesium was added. When the shaker rotated at 200 rpm, addition of magnesium at 97.2 ppm concentration significantly increases the chloride removal percentage compared with when no magnesium was added. The method improves efficiency of chloride removal and makes it possible to use cheap materials for holding the water solutions or slurries since chloride concentration is reduced, which in turn reduces the cost the whole water treatment system.

The embodiments described herein are examples of compositions, structures, systems, and methods having elements corresponding to the elements of the invention recited in the claims. This written description may enable those of ordinary skill in the art to make and use embodiments having alternative elements that likewise correspond to the elements of the invention recited in the claims. The scope of the invention thus includes compositions, structures, systems and methods that do not differ from the literal language of the claims, and further includes other structures, systems and methods with insubstantial differences from the literal language of the claims. While only certain features and embodiments have been illustrated and described herein, many modifications and changes may occur to one of ordinary skill in the relevant art. The appended claims cover all such modifications and changes.

1. A method for removing chloride from an aqueous solution having an initial chloride ion (Cl⁻) weight concentration, comprising:
adding a magnesium compound to the aqueous solution, magnesium ion weight concentration being less than about 20% of the initial chloride ion weight concentration;
adding at least two compounds comprising calcium ions (Ca²⁺), hydroxide ions (OH⁻) and aluminate ions (AlO₂⁻), wherein pH of the aqueous solution is greater than about 10 after addition of the at least two compounds; and
stirring for precipitation.

2. The method of claim 1, wherein calcium ions (Ca²⁺) weight concentration in the aqueous solution is from about 5 times to about 10 times of the initial chloride ion (Cl⁻) weight concentration.

3. The method of claim 1, wherein aluminate ions (AlO₂⁻) weight concentration in the aqueous solution is from about 1 time to about 3 times of the initial chlorine ion (Cl⁻) weight concentration.

4. The method of claim 1, wherein magnesium ion weight concentration in the aqueous solution is from about 2% to about 15% of the initial chloride ion (Cl⁻) weight concentration.

5. The method of claim 1, wherein a power consumption of the stirring is in a range of from about 10 W/m³ to about 55 W/m³.

6. The method of claim 1, wherein when a power consumption of the stirring is about about 28 W/m³, magnesium ion (Mg²⁺) weight concentration is about 6% to about 15% of the initial chloride ion (Cl⁻) weight concentration in the aqueous solution.

7. The method of claim 1, being operated at a temperature of 20˜25° C.

8. The method of claim 1, wherein the at least two compounds comprise calcium hydroxide and sodium aluminate.

9. The method of claim 1, wherein the at least two compounds comprise calcium oxide and sodium aluminate.

10. The method of claim 9, wherein the at least two compounds comprise sodium hydroxide.

11. The method of claim 1, wherein the at least two compounds comprise calcium aluminate and sodium hydroxide.

12. The method of claim 11, wherein the at least two compounds comprise calcium hydroxide or calcium nitrate.

13. The method of claim 1, wherein the at least two compounds comprise calcium aluminate and calcium hydroxide.

14. The method of claim 1, wherein the magnesium compound comprises magnesium chloride or magnesium nitrate.

15. The method of claim 1, wherein pH of the aqueous solution is greater than about 12 after addition of the at least two compounds.

16. The method of claim 1, wherein a power consumption of the stirring is about 11.7 W/m³.

17. The method of claim 1, wherein a power consumption of the stirring is about 54.1 W/m³ and magnesium ion weight concentration in the aqueous solution is from about 2% to about 7% of the initial chloride ion weight concentration.
